(19) United States
(12) Patent Application Publication
(10) Pub. No.: US 2007/0049201 A1
(43) Pub. Date: Mar. 1, 2007

(54) Wireless LAN system having priority data transmission function

(75) Inventors: Yuuji Nagano, Fukuoka (JP); Yuji Nomura, Fukuoka (JP)

Correspondence Address: BINGHAM MCCUTCHEN LLP, 3000 K STREET, NW, BOX IP, WASHINGTON, DC, 20007, US

(73) Assignee: Fujitsu Limited

(21) Appl. No.: 11/288,308

(22) Filed: Nov. 29, 2005

(30) Foreign Application Priority Data
Aug. 30, 2005 (JP) JP2005-249774

(51) Int. Cl. H04B 1/00; H04B 15/00

(52) U.S. Cl. 455/63.2

(57) ABSTRACT

A communication control device constitutes an access point of a wireless LAN system. The communication control device includes a unit receiving a movement advance notification of a terminal into a wireless zone under control; and a unit transmitting a transmission standby instruction so that a terminal transmitting data is brought into a wait state and a movement target terminal moving into the wireless zone under the control is allowed to transmit data by priority upon reception of the movement advance notification.

### BACKGROUND OF THE INVENTION

The present invention relates to a wireless LAN (Local Area Network) system, in particular, to a wireless LAN system enabling priority (immediate) data transmission when a terminal moves into a wireless (radio) zone under the control of a new access point.

Normally, in a wireless LAN system, in the case where a plurality of terminals (also referred to as wireless LAN terminals or mobile terminals) are present in one wireless zone (a wireless LAN zone or a service area) and an access point controlling the wireless zone and one terminal communicate with each other, the other terminals present in the wireless zone or terminals moving thereto from another wireless zone are required to wait for data transmission until the currently communicating terminal terminates data transmission to prevent the collision of data transmission.

In wireless LAN standards defined by IEEE (Institute of Electrical and Electronics Engineers) (IEEE 802.11), access control for allowing the same wireless channel (radio frequency channel) to be shared by a plurality of terminals is defined. In the access control, when a terminal desires to transmit data to an access point (sometimes referred to simply as an AP), the terminal first receives a radio signal to determine whether a radio signal from another terminal is present on a wireless communication path (a wireless line) or not. In the receiving operation, it is not necessary to demodulate data that is modulated into the radio signal. The presence of an electromagnetic wave (a signal level of an electromagnetic wave) is merely confirmed.

The operation is generally called carrier sense (see FIG. 1). When data communication is performed between an AP and a plurality of terminals in the same wireless zone by using the same wireless channel (wireless line), the collision of data transmission from the plurality of terminals is prevented based on the carrier sense operation.

As shown in FIG. 1, when the terminal does not receive an electromagnetic wave signal as a result of the implementation of carrier sense, it is determined that the wireless channel is in an unused state (an idle state) so that the data transmission is performed. However, when the terminal receives the electromagnetic wave signal, it is determined that the wireless channel is in a used state (a busy state) so that the terminal waits for the end of the current packet transmission by the other terminals (interference sources 1 and 2). After the carrier sense is implemented again to confirm the idle state where the wireless channel is free, the data transmission is performed. Therefore, when the terminal performs the data transmission while moving between pluralities of APs (in a strict sense, between wireless zones under the control of a plurality of APs), it is not until the implementation of the carrier sense that the possibility of immediate data transmission is known at the destination.

FIG. 2 shows an access procedure between pluralities of terminals using the carrier sense described above. As shown in FIG. 2, a terminal B determines as a result of carrier sense that the wireless channel is busy during the data transmission of a terminal A so as not to transmit data. In this case, after the terminal B waits for an IFS (Inter Frame Space: transmission interval) and then implements the carrier sense again at a back-off time (random time), it confirms an idle state of the wireless channel to perform the data transmission. While the terminal B is transmitting data, the terminal A determines that the wireless channel is busy and waits for data transmission.

FIG. 3 is a view for explaining a problem in a wireless LAN system when a terminal moves. As shown in FIG. 3, in the case where a terminal moves between wireless zones under the control of a plurality of access points AP1 and AP2 connected to a wired network (a wired NW) as shown in FIG. 3, a wireless channel CH1 is in a busy state when another terminal 2 and the AP2 are already in communication with each other through the wireless channel CH1. In the access control, the terminal 1 moving from the wireless zone under the control of the AP1 has to wait until the communication ends. Therefore, the access from the terminal 1 that desires to transmit data by priority is obstructed by the communication of the other terminal 2 in the wireless zone under the control of the AP2.

FIG. 4 is a view showing data communication in a wireless LAN system between an access point AP and terminals A and B. As shown in FIG. 4, after the data transmission of the terminal A, the terminal B can transmit data after waiting for an SIFS (a Short Inter Frame Space: short frame interval) and a DIFS (Distributed Coordination Function Inter Frame Space:frame space for distributed control) corresponding to frame intervals, a data transmission ACK receiving time and a random time (back-off time). The frame intervals (the SIFS and the DIFS) and the back-off time are defined in the wireless LAN standards IEEE 802.11 to avoid data transmission collision between the plurality of terminals.

In Japanese Patent Laid-Open Publication No. 2003-348007 (Patent document 1), a terminal regularly transmits an employed wireless channel (the amount of wireless resource) to an AP to perform communication with the same reliability as that before movement of the terminal even after the movement between APs. In the technique described in the Patent document 1, the destination AP notifies the source AP of the wireless channel (the amount of wireless resource) used at the destination AP. The source AP transmits a resource reservation request to the Destination AP if the resource of a mobile terminal can be reserved at the destination AP. When the wireless channel (the wireless resource) is set, data communication with the same reliability as that before the movement is enabled. FIG. 5 is a view showing the related art.

As shown in FIG. 5, at the AP1, information of the employed wireless channel (the amount of wireless resource) notified from the terminal 1 and the amount of wireless resource at the AP2 connected to the wired network (the wired NW) are compared with each other. If the wireless resource for a mobile terminal 1 can be reserved at the AP2, the AP2 is notified of the resource reservation to ensure a connecting state (reliability) before the movement.

FIG. 6 is a view for explaining a problem in the related art. As shown in FIG. 6, when the other terminals 2 and 3 are already connected to the destination AP2 to perform data communication, the amount of used wireless resource is too large to reserve the wireless resource for the mobile terminal 1. Therefore, stable communication of the mobile terminal 1 cannot be ensured.

FIG. 7 is a view for explaining a remedial measure to solve the problem in the technique described in the Patent document 1. Since the remedial measure is employed in the present invention, only the general description is given herein and the detailed description will be given below. As shown in FIG. 7, when the terminal 1 moves from the AP1 to the AP2, the AP2 is notified of the movement through the wired NW. The notified AP2 transmits a data transmission standby instruction to the terminal 2 under its control. According to the measure, since the other terminal 2 in the destination wireless zone is brought into a transmission standby state regardless of the amount of used wireless resource, the terminal 1 moving thereto can transmit data by priority to the AP2 without being obstructed by the data transmission of the other terminal 2 even if the other terminal 2 is already connected to the destination AP2 so that a full amount of wireless resource is used.

Moreover, in Japanese Patent Laid-Open Publication No. 2001-103531 (Patent document 2), in order to enable efficient movement of the terminal between a plurality of APs, connection information between each AP and the terminals is collected to give priorities to the terminals in the order of higher statistical possibility of movement to select a frequency (a channel) of the wireless zone under the control of the destination AP. In the technique described in the Patent document 2, the wireless channel used by the destination AP is informed in advance based on statistical information. As a result, a connection processing at the movement of the terminal can be efficiently performed. FIG. 8 is a view showing the related art.

As shown in FIG. 8, the AP1 collects connection information of the AP2 and the AP3 and notifies the terminal 1 under the control of the AP1 of the connection information. When moving, the terminal 1 selects the wireless channel of the AP2 having the highest possibility of serving as the destination AP. As a result, the connection processing at the movement can be smoothly implemented. In the related art, however, importance is placed on the connection (wireless linkup) processing. Therefore, data transmission after connection is not taken into consideration.

FIG. 9 is a view for explaining a problem in the related art. As shown in FIG. 9, in the wireless zone under the control of the AP2 corresponding to the destination of the terminal 1, when the AP2 already performs data communication with the other terminal 2, the terminal 1 moving thereto is made to wait until the end of communication. Therefore, even if the connection can be established immediately after the movement, data communication is not possible.

FIG. 10 is a view for explaining a remedial measure to solve the problem in the technique described in the Patent document 2. Since the remedial measure is employed in the present invention, only the general description is given and the detailed description will be given below. As shown in FIG. 10, the AP2 instructs the terminal 2 in the wireless zone of the destination AP2 to wait for data transmission before the movement of the terminal 1 so that the terminal 1 can transmit data even immediately after the movement.

The following are related arts to the present invention.

[Patent Document 1]

Japanese Patent Laid-Open Publication No. 2003-348007

[Patent Document 2]

Japanese Patent Laid-Open Publication No. 2001-103531

### SUMMARY OF THE INVENTION

An object of the present invention is to provide a technique of enabling priority (immediate) data transmission to a terminal (a movement target terminal) when the terminal moves into a wireless zone under the control.

To solve the above problems, a communication control device constituting an access point of a wireless LAN system according to the present invention includes: a unit receiving a movement advance notification of a terminal into a wireless zone under control; and a unit transmitting a transmission standby instruction so that a terminal transmitting data is brought into a wait state and a movement target terminal moving into the wireless zone under the control is allowed to transmit data by priority upon reception of the movement notification.

The communication control device can further employ the following constructions.

The communication control device according to the invention, further includes a unit transmitting a transmission start instruction for allowing the terminal in the standby state to restart the data transmission upon reception of a data transmission completion notification from the movement target terminal.

The communication control device according to the invention, further includes: a unit generating a timer value after transmission of the transmission standby instruction; and a unit transmitting a transmission start instruction allowing the terminal in the standby state to restart the data transmission.

The communication control device according to the invention, further includes: a unit storing identification information of a terminal that is not brought into a complete standby state for data transmission; and a unit allowing the terminal not being in the standby state to perform interrupt data transmission during data transmission of the movement target terminal based on a search of the identification information.

The communication control device according to the invention, further includes a unit receiving the movement notification to bring the terminal transmitting data into the standby state and for further transmitting a transmission standby instruction to a newly connected terminal in the wireless zone to allow the movement target terminal moving into the wireless zone under the control to transmit data by priority.

According to the present invention, the movement target terminal, which moves into the wireless zone under the control, is allowed to perform priority (immediate) data transmission. Therefore, for example, it is ensured that important data with urgency can be collected by a monitor center on a wired network.

The other objects, features and advantages of the present invention will be apparent by reading the following embodiment with reference to the drawings and the accompanying Scope of Claims.

### BRIEF DESCRIPTION OF THE DRAWINGS

FIG. 1 is a view for explaining carrier sense in a wireless LAN system;

FIG. 2 is a view showing an access procedure between a pluralities of terminals using the carrier sense;

FIG. 3 is a view for explaining a problem in a wireless LAN system when a terminal moves;

FIG. 4 is a view for explaining data communication in the wireless LAN system;

FIG. 5 is a view for explaining an operation in a related art;

FIG. 6 is a view for explaining a problem in the related art;

FIG. 7 is a view for explaining a remedial measure of the problem in the related art;

FIG. 8 is a view for explaining an operation in further related art;

FIG. 9 is a view for explaining a problem in the further related art;

FIG. 10 is a view for explaining a remedial measure of the problem in the further related art;

FIG. 11 is a view for explaining the schema of a wireless LAN system in an embodiment of the present invention;

FIG. 12 is a view showing a terminal movement notification frame;

FIG. 13 is a view showing a transmission standby frame;

FIG. 14 is a view showing a transmission standby timer table;

FIG. 15 is a view showing a transmission standby designation frame;

FIG. 16 is a view showing an operation procedure of an access point when a new terminal is connected;

FIG. 17 is a view showing an operation procedure of monitoring movement (disconnection) of a terminal at an access point;

FIG. 18 is a view showing the operation procedure of monitoring movement (disconnection) of the terminal at the access point;

FIG. 19 is a view showing an operation sequence in the wireless LAN system shown in FIG. 11;

FIG. 20 is a view for explaining a fundamental structure of a specific example of a wireless LAN system in an embodiment of the present invention;

FIG. 21 is a view for explaining a fundamental structure of an access point and terminals in the wireless LAN system shown in FIG. 20;

FIG. 22 is a view for explaining a first operation example;

FIG. 23 is a view for explaining the first operation example;

FIG. 24 is a view for explaining the first operation example;

FIG. 25 is a view for explaining the first operation example;

FIG. 26 is a view for explaining a second operation example;

FIG. 27 is a view for explaining the second operation example;

FIG. 28 is a view for explaining the second operation example;

FIG. 29 is a view for explaining the second operation example;

FIG. 30 is a view for explaining a third operation example;

FIG. 31 is a view for explaining the third operation example;

FIG. 32 is a view for explaining the third operation example;

FIG. 33 is a view for explaining the third operation example;

FIG. 34 is a view for explaining a fourth operation example; and

FIG. 35 is a view for explaining the fourth operation example.

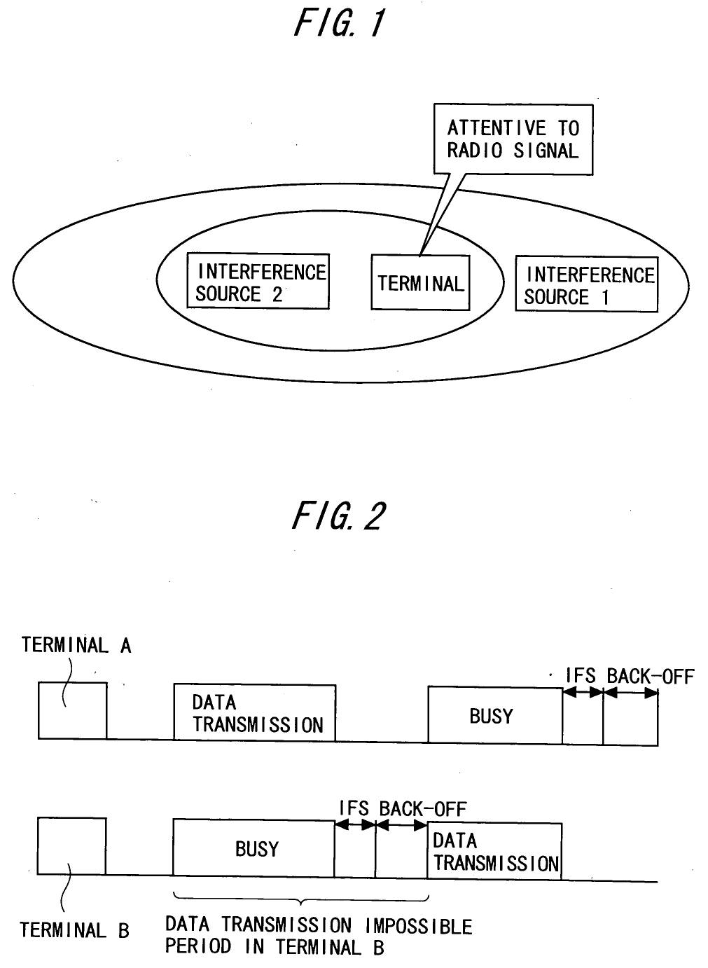

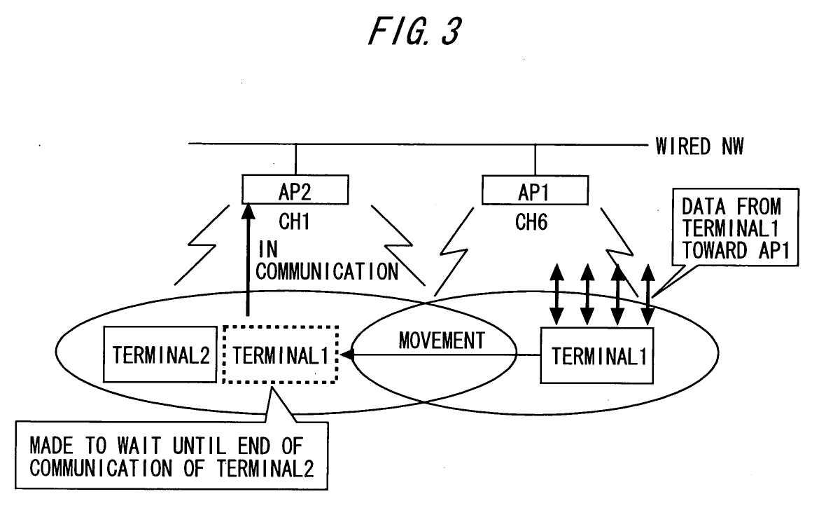

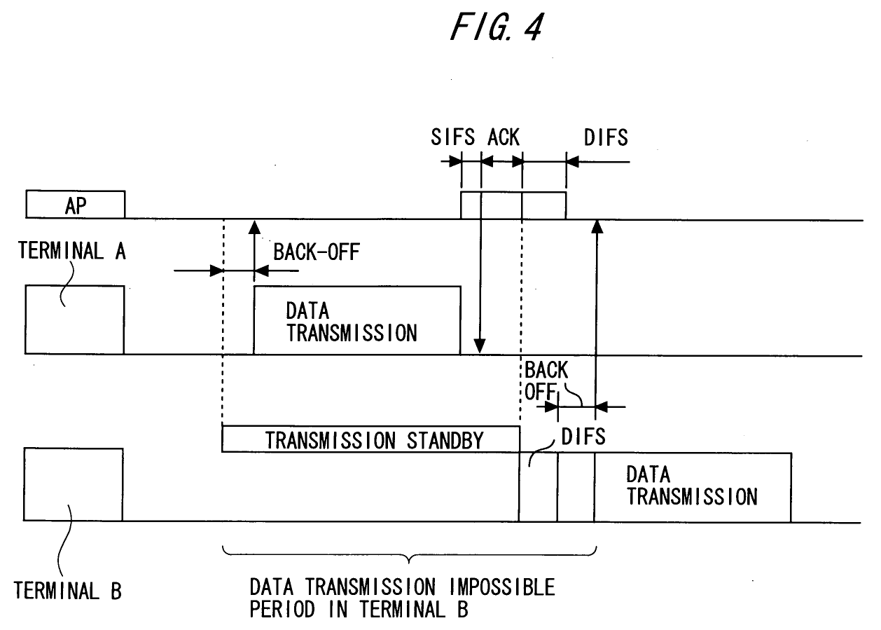

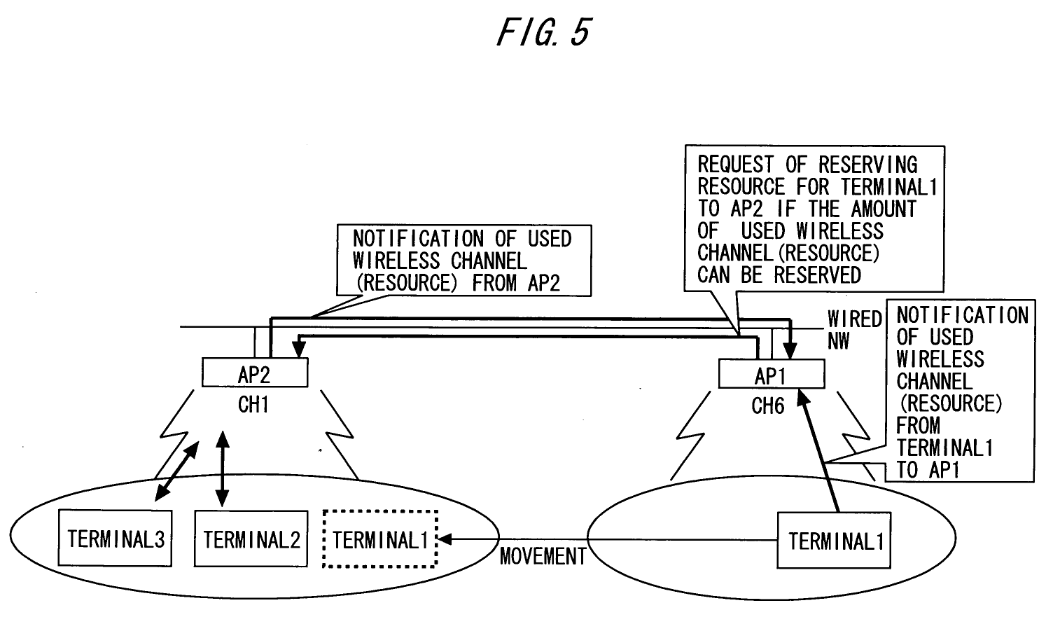

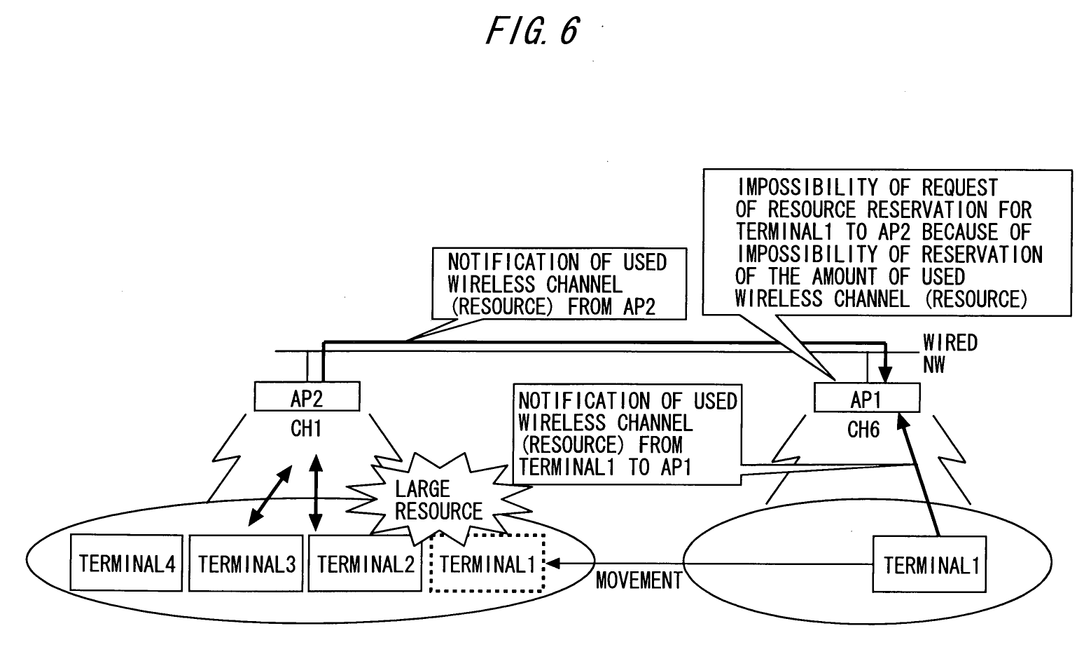

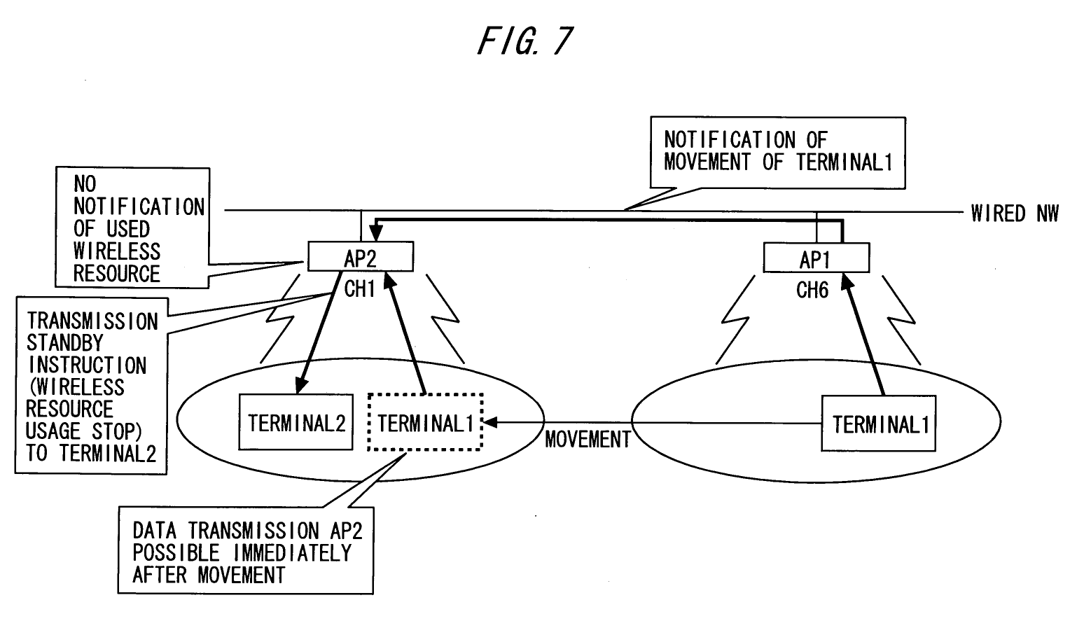

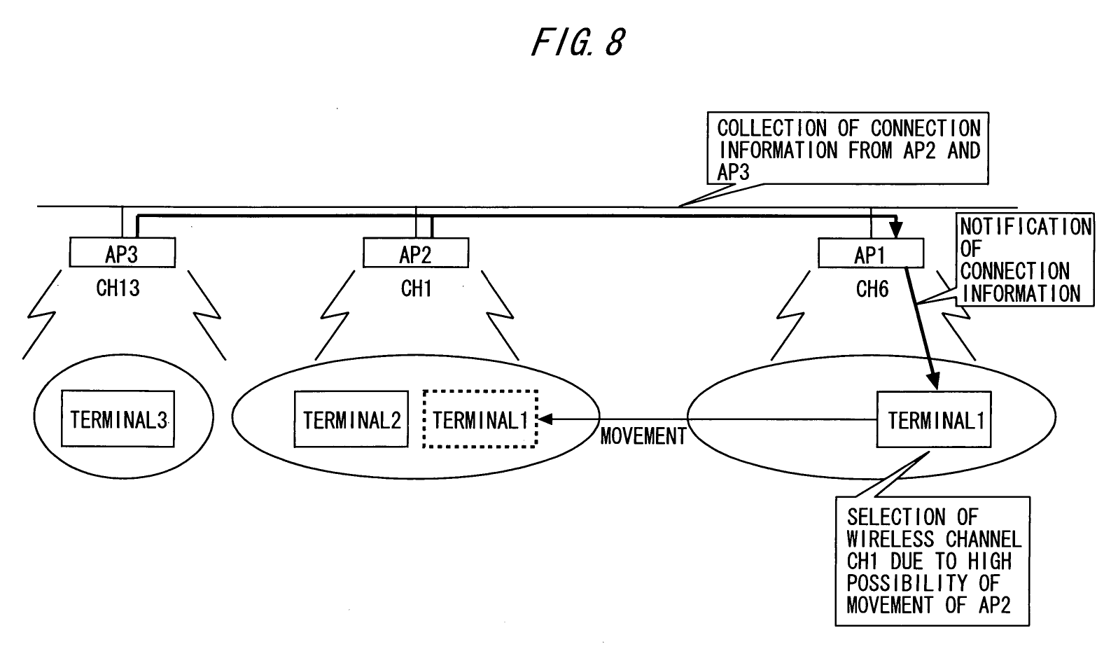

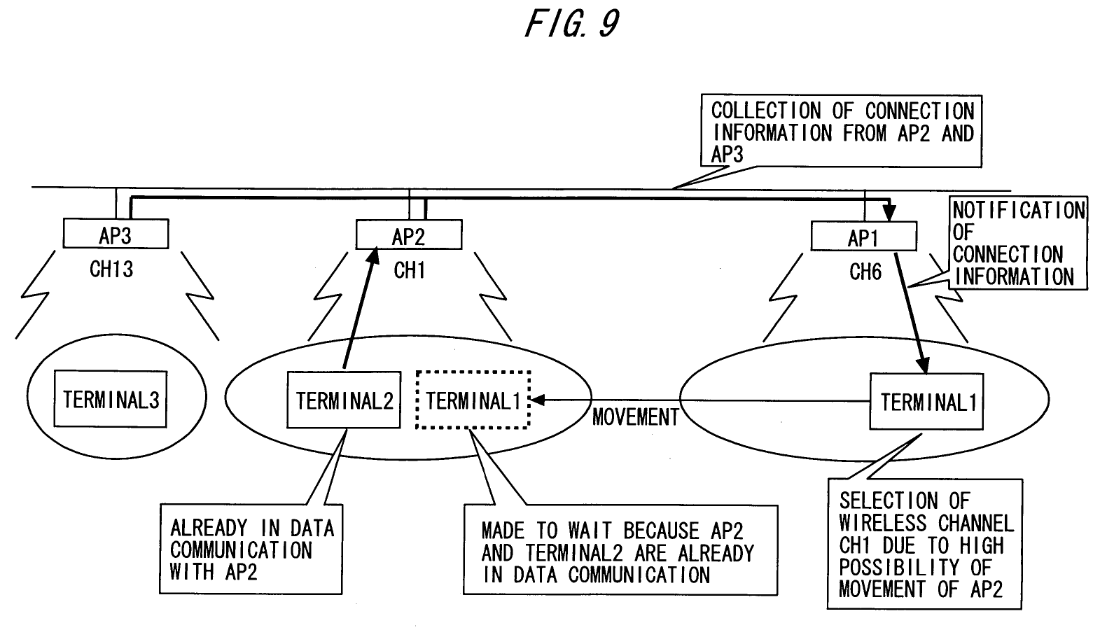

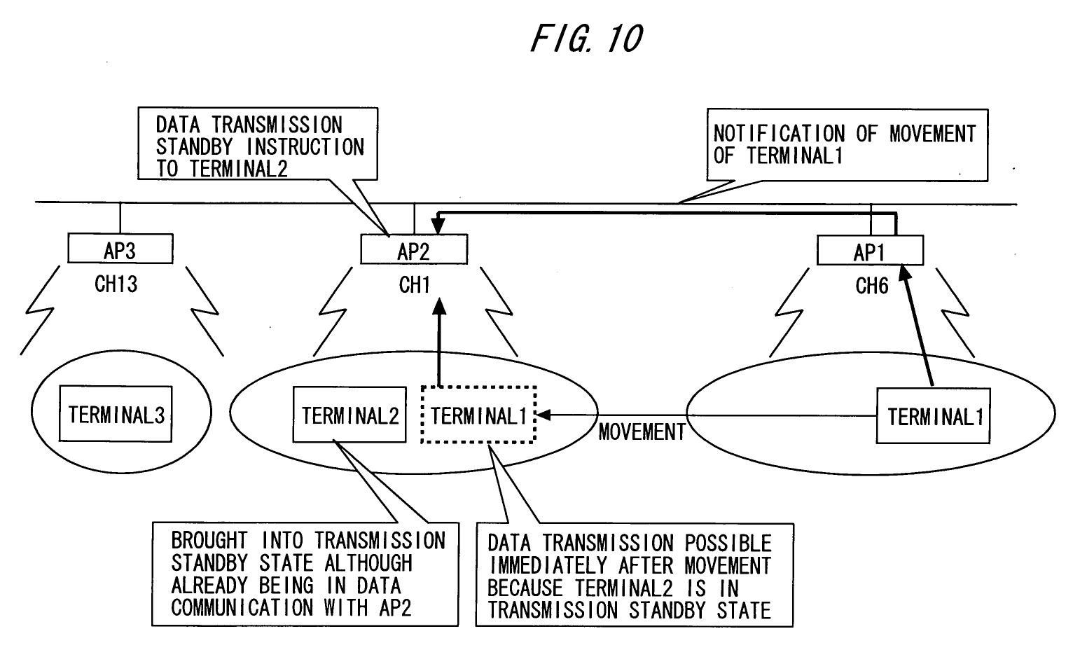

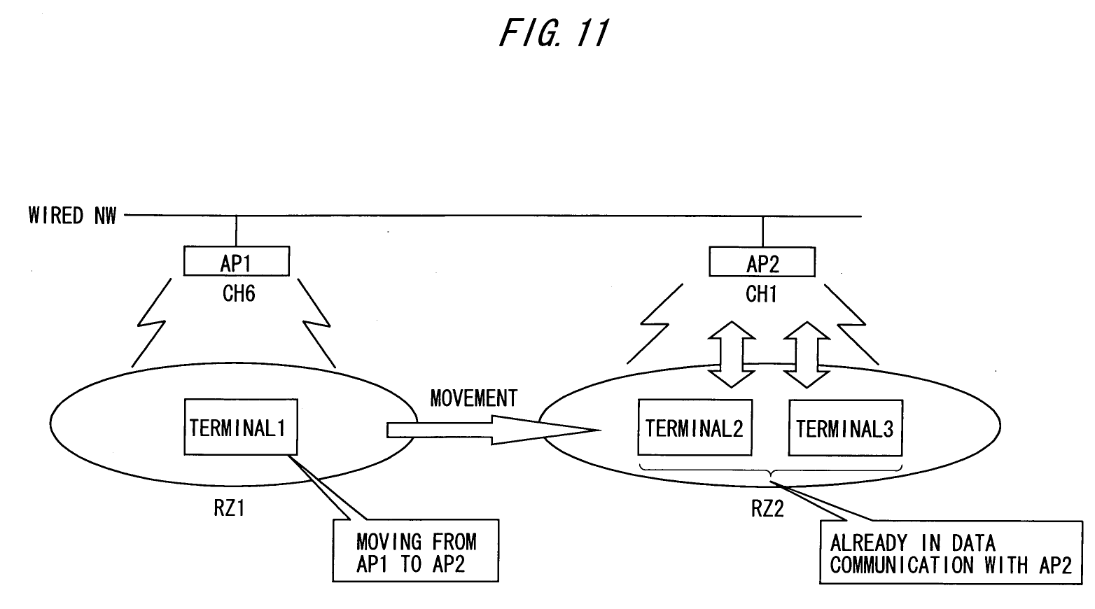

### DETAILED DESCRIPTION OF THE PREFERRED EMBODIMENTS

Hereinafter, the present invention will be described in further detail with reference to the accompanying drawings. The preferred embodiments of the present invention are illustrated in the drawings. However, the present invention can be carried out in various different modes and should not be read as being limited to the embodiments described in this specification. The embodiments are rather given to render the disclosure of the specification comprehensive and complete so that those skilled in the art fully understand the scope of the present invention.

[Schema of Wireless LAN System]

First, the schema of a wireless LAN (Local Area Network) system in an embodiment of the present invention will be described.

FIG. 11 is a view for explaining a wireless LAN system in an embodiment of the present invention. Referring to FIG. 11, in the wireless LAN system, a plurality of access points (in a strict sense, communication control devices, each constituting an access point) AP1 and AP2 are logically connected in cascade arrangement to a wired network (a wired NW) constituted by a wired LAN. A wireless channel (a wireless line) CH6 is used in a wireless or radio zone (a wireless LAN zone or a service area) RZ1 under the control of the access point AP1, whereas a wireless channel CH1 is used in a wireless zone RZ2 under the control of the access point AP2. Each of the access points AP1 and AP2 and terminals (wireless LAN terminals or mobile terminals) 1, 2 and 3 operates with a wireless frequency signal assigned to it.

Herein, the terminal 1 in the wireless zone RZ1 under the control of the access point AP1 (hereinafter, also referred to as the terminal under the control of the access point) moves into the wireless zone RZ2 under the control of the access point AP2. In the wireless zone RZ2 under the control of the access point AP2, the plurality of terminals 2 and 3 are already present to perform data communication with the access point AP2.

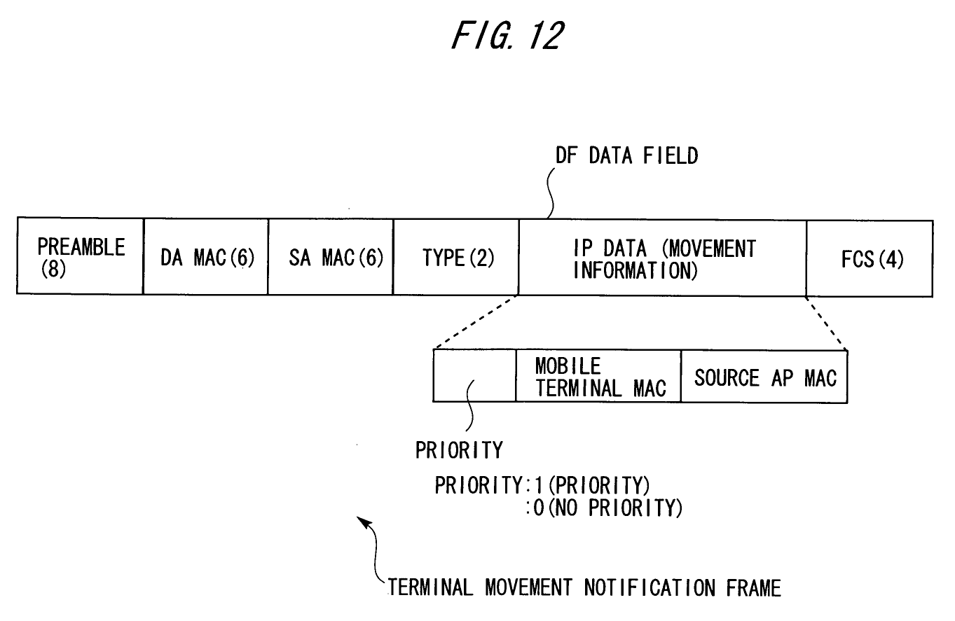

FIG. 12 shows a frame (a terminal movement notification frame) for advance notification of movement of a terminal performing transmission from the access point AP1 to the access point AP2 through the wired NW when the terminal, which is preregistered at the access point AP1 as being capable of performing priority data transmission, moves in the wireless LAN system shown in FIG. 11. In the case where a priority bit in IP (Internet Protocol) data (movement information) in a data field DF of the terminal movement notification frame received at the access point AP2 is a “1” (priority) state, the access point AP2 transmits a frame for instructing the terminals 2 and 3 under its control to wait for transmission (a transmission standby frame) so that the priority is given to the data transmission of the terminal 1 corresponding to a mobile terminal MAC address described in the data field DF in the frame.

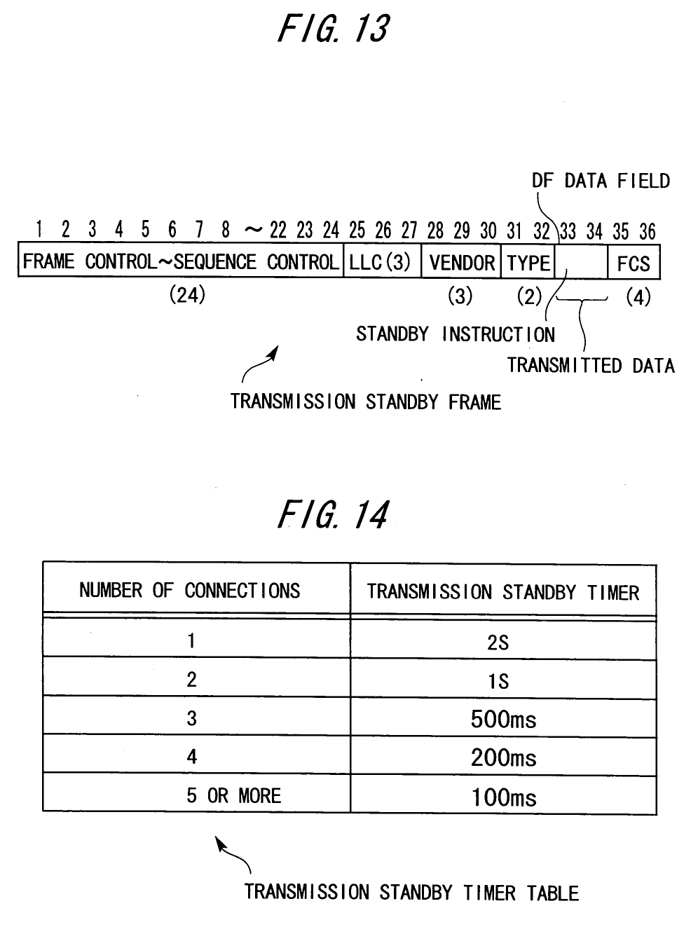

FIG. 13 shows an example of the transmission standby frame transmitted from the access point AP2 to the terminals 2 and 3 under its control. The terminals 2 and 3 under the control of the access point AP2, which receive the transmission standby frame with the standby instruction bit in the data field DF being “1”, stop the data transmission. After transmitting data to the access point AP2, the terminal 1 moving thereto transmits a data transmission completion notification.

FIG. 14 shows a transmission standby timer table provided in the access point AP2. The table shows that a transmission standby duration (time) varies in accordance with the number of terminals to which the access point AP2 is connected. Since it is expected that the frequency of data transmission is increased as the number of connected terminals increases, the transmission standby duration is reduced.

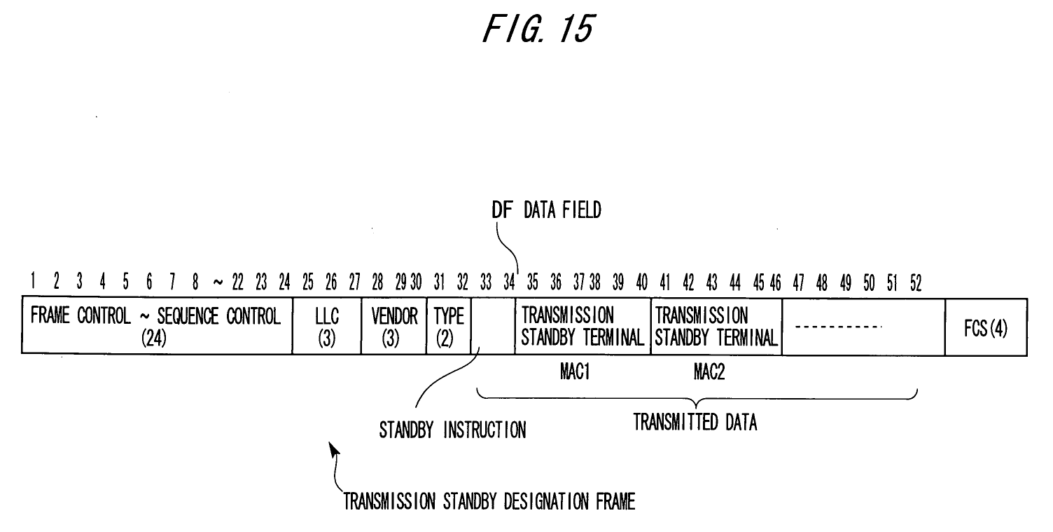

FIG. 15 shows a transmission standby designation frame transmitted from the access point AP2 to the terminals 2 and 3 under its control. By designating a destination MAC address with a transmission standby terminal designation bit that follows the standby instruction bit in the data field DF, the terminals 2 and 3 to be made to wait for transmission can be designated.

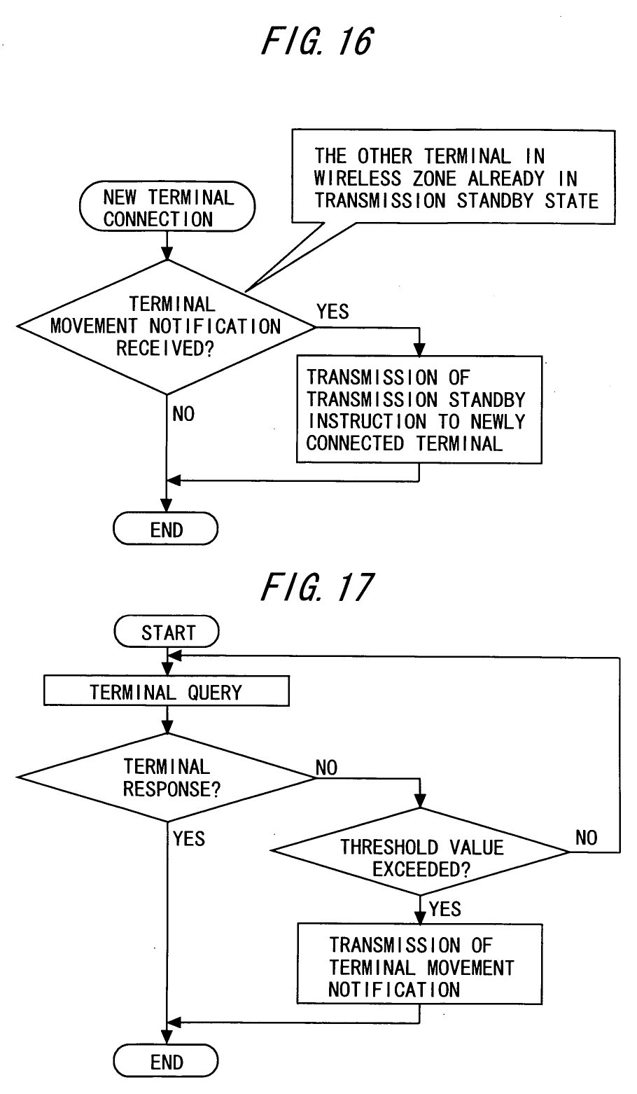

In the wireless LAN system having the priority data transmission function, when a new terminal that does not have data transmission priority is connected while a terminal in the wireless zone is already in a transmission standby state, the transmission standby instruction can be issued to the new terminal. FIG. 16 shows the operation procedure at the access point AP. Even if the terminal that does not have data transmission priority is newly connected in the data transmission standby state, the access point AP transmits the transmission standby instruction to the new terminal to prevent the terminal performing priority data transmission from being obstructed (interrupted).

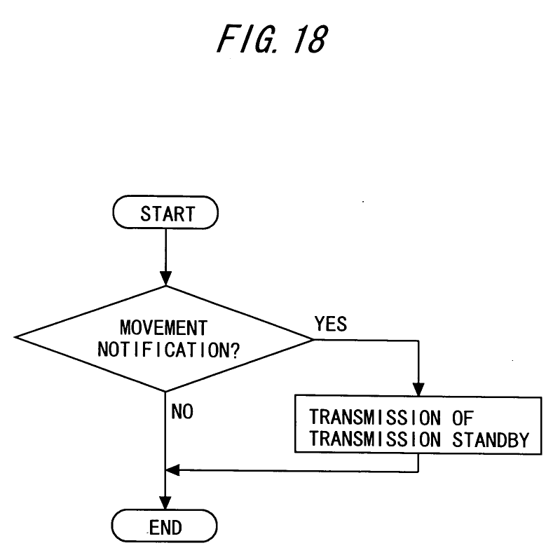

Moreover, in the wireless LAN system, as shown in FIG. 17, the access point AP confirms the presence of a terminal in the wireless zone under its control through regular connection between the access point AP and the terminals based on the operation procedure of monitoring the movement (disconnection) of the terminals. Moreover, when the access point AP receives a movement notification from the wired NW after the disconnection of the terminal, the access point AP transmits the transmission standby frame to the terminal under its control based on the operation procedure shown in FIG. 18.

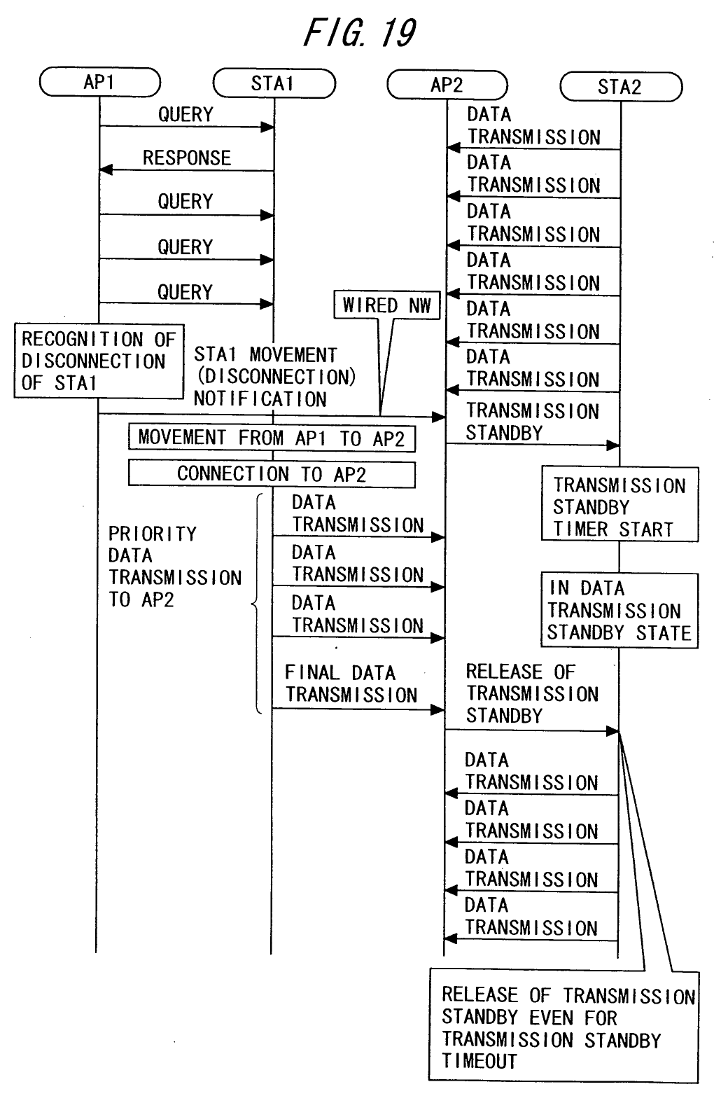

In the wireless LAN system having the priority data transmission function described above, as shown in FIG. 19, when the terminal 1 (STAL) connected to the access point AP1 moves to the access point AP2, the access point AP1 transmits a movement (disconnection) notification of the terminal 1 to the access point AP2 through the wired NW. The access point AP2 transmits the transmission standby instruction to the terminal 2 (STA2) under its control. The terminal 2 waits for data transmission until it receives an instruction indicating transmission standby release or until transmission standby timeout. Meanwhile, the terminal 1 has priority in data transmission to the access point AP2. Although the terminal 3 (STA3) in FIG. 11 is not illustrated in the operation sequence shown in FIG. 19, it operates in the same manner as that of the terminal 2.

### Specific Example of Wireless LAN System

Next, a specific example of a wireless LAN system in an embodiment of the present invention will be described.

(Fundamental Structure)

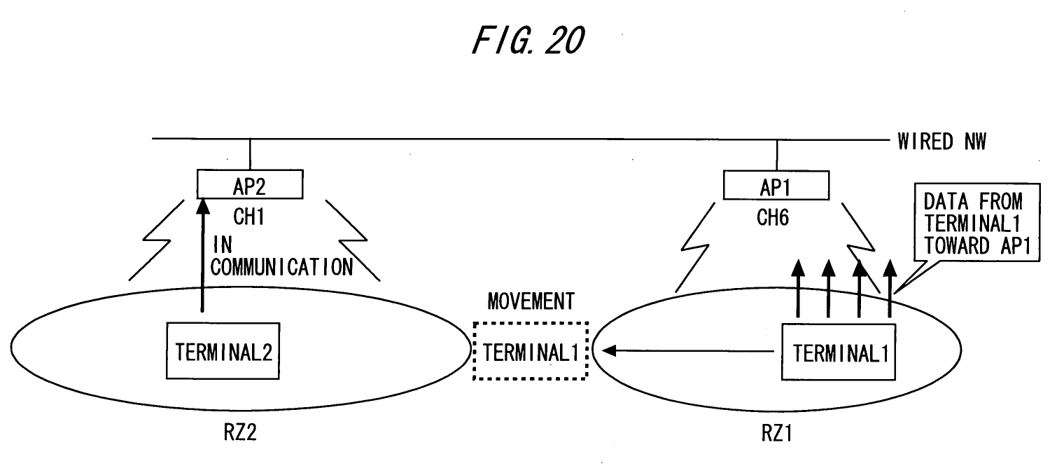

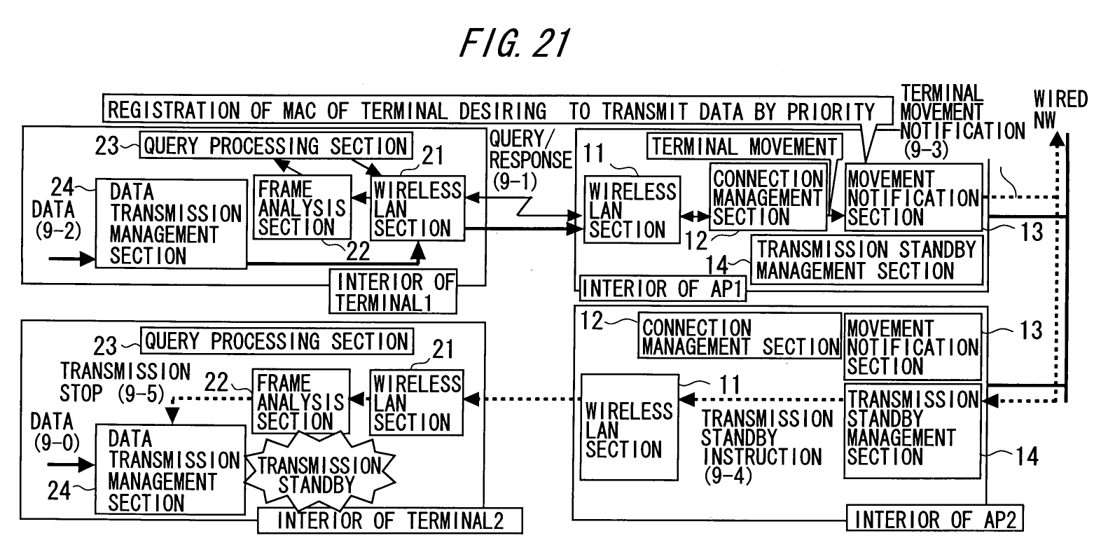

FIG. 20 is a view for explaining a fundamental structure of a wireless LAN system in an embodiment of the present invention. FIG. 21 is a view showing a fundamental structure of the access points AP1 and AP2 and the terminals 1 and 2 in the wireless LAN system shown in FIG. 20.

An environment of the wireless LAN system having the priority data transmission function shown in FIG. 20 is fundamentally the same as that of the wireless LAN system shown in FIG. 11. Specifically, in the wireless LAN system, the plurality of access points AP1 and AP2 are logically connected in cascade arrangement to the wired network (the wired NW) constituted by the wired LAN. The wireless channel CH6 is used in the wireless zone RZ1 under the control of the access point AP1, whereas the wireless channel CH1 is used in the wireless zone RZ2 under the control of the access point AP2. Each of the access points AP1 and AP2 and the terminals 1 and 2 operates at a wireless frequency signal assigned to it.

Herein, the terminal 1 present in the wireless zone RZ1 under the control of the access point AP1 moves from the wireless zone RZ1 into the wireless zone RZ2 under the control of the access point AP2. In the wireless zone RZ2 under the control of the access point AP2, the terminal 2 is already present to perform data communication with the access point AP2.

Referring to FIG. 21, each of the access points (the communication control devices) AP1 and AP2 includes, as a fundamental structure, a wireless LAN section 11, a connection management section 12, a movement notification section 13 and a transmission standby management section 14. Each of the wireless LAN sections 11 performs communication (wireless LAN communication) in a wireless area (a wireless LAN area) with a corresponding terminal through a predetermined wireless channel. Each of the connection management sections 12 confirms a connection query request and a response with the corresponding terminal. Each of the movement notification sections 13 generates a terminal movement (advance) notification and transmits it to the other access point AP connected to the wired NW if the terminal that desires to transmit data by priority cannot be registered or the connection with the registered terminal cannot be confirmed. When receiving the terminal movement notification from the wired NW, each of the transmission standby management sections 14 generates a transmission standby instruction and transmits it to the terminal under its control through the wireless LAN section 11.

Each of the terminals 1 and 2 includes a wireless LAN section 21, a frame analysis section 22, a query processing section 23 and a data transmission management section 24. Each of the wireless LAN sections 21 performs wireless LAN communication with a corresponding access point. Each of the frame analysis sections 22 analyzes a frame from the corresponding access point to perform a sorting processing of the received frame. Each of the query processing sections 23 generates a response frame to the connection query from the corresponding access point and transmits it to the wireless LAN section 21. Each of the data transmission management sections 24 manages the start and the stop of data transmission. At the same time, when receiving a transmission stop instruction from the frame analysis section 22, the data transmission management section stops the data transmission.

(Fundamental Operation)

Referring collectively to FIGS. 20 and 21, in the wireless LAN system, the query for confirming the connection from the access point AP1 and the response to it (a procedure 9-1) are implemented through the wireless LAN sections 11 and 21 between the access point AP1 connected to the wired NW, and the terminal 1 under its control. The data transmission management section 24 of the terminal 1 transmits data (a procedure 9-2) to the access point AP 1 through the wireless area.

A MAC address of the terminal 1 that desires to transmit data by priority is preregistered in the movement notification section 13 of the access point AP1. When the terminal 1 does not respond to a query from the access point AP1 (in other words, the terminal 1 moves out of the wireless zone RZ1 of the access point AP1), the movement notification section 13 transmits a terminal movement notification (a procedure 9-3) to the other access point AP2 connected to the wireless NW.

The transmission standby management section 14 of the access point AP2 receiving the terminal movement notification transmits a transmission standby instruction (a procedure 9-4) to the terminal 2 under its control through the wireless LAN section 11. The frame analysis section 22 of the terminal 2 receiving the transmission standby instruction through the wireless LAN section 21 instructs the data transmission management section 24 to stop the data transmission to the access point AP2 (a procedure 9-5). When the terminal 1 moves to the access point AP2 in this state, the terminal 1 can transmit data by priority to the access point AP2 because the terminal 2 having transmitted data to the access point AP2 is no longer present (in other words, in a data transmission standby state).

### First Operation Example

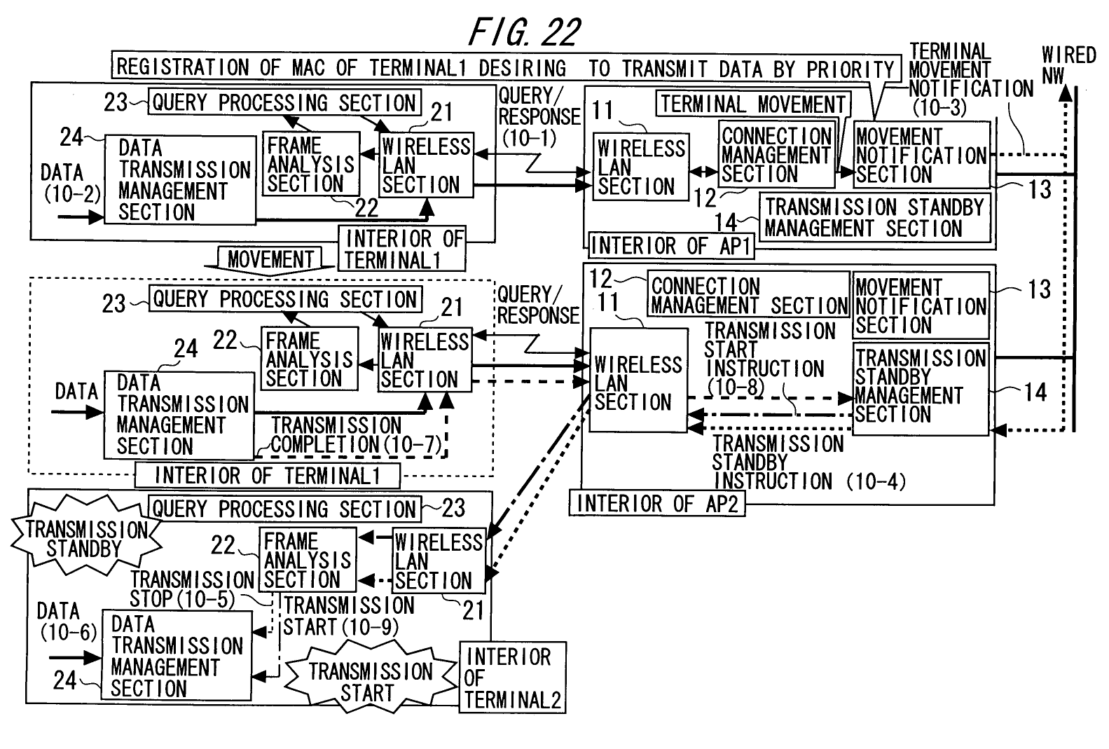

As shown in FIG. 22, between the access point AP1 connected to the wired NW and the terminal 1 in the wireless zone RZ1 under the control of the access point AP1, the query for confirming the connection from the access point AP1 and the response to it (a procedure 10-1) are implemented through the wireless LAN sections 11 and 21. The data transmission management section 24 of the terminal 1 transmits data (a procedure 10-2) to the access point AP1 through the wireless area.

A MAC address of the terminal 1 is preregistered as a terminal that desires to transmit data by priority in the movement notification section 13 of the access point AP1. When the terminal 1 does not respond to the query from the access point AP1, that is, it is determined that the terminal 1 exits from the wireless zone RZ1 of the access point AP1, the movement notification section 13 transmits a terminal movement notification (a procedure 10-3) to the other access point AP2 connected to the wired NW by using the terminal movement notification frame shown in FIG. 12.

The transmission standby management section 14 of the access point AP2 receiving the terminal movement notification transmits a transmission standby instruction (a procedure 10-4) to the terminal 2 under its control through the wireless LAN section 11. In the terminal 2, the frame analysis section 22 receiving the transmission standby instruction through the wireless LAN section 21 instructs the data transmission management section 24 to stop the data transmission (a procedure 10-5) to stop the data transmission to the access point AP2.

The terminal 1 moves from the wireless zone RZ1 to the wireless zone RZ2 to be connected to the access point AP2. Since there is no terminal transmitting data to the access point AP2 at this time, the data transmission to the access point AP2 is possible. In the terminal 1, when the data transmission to the access point AP2 is completed, the data transmission management section 24 notifies the access point AP2 of the completion of transmission (a procedure 10-7) through the wireless LAN section 21.

At the access point AP2, the transmission standby management section 14 receiving the transmission completion notification through the wireless LAN section 11 transmits a transmission start instruction (a procedure 10-8) to the terminal 2 in the transmission standby state under its control through the wireless LAN section 11. The frame analysis section 22 of the terminal 2 receiving the transmission start instruction through the wireless LAN section 21 instructs the data transmission management section 24 to start the transmission (a procedure 10-9) to allow the data transmission to be restarted.

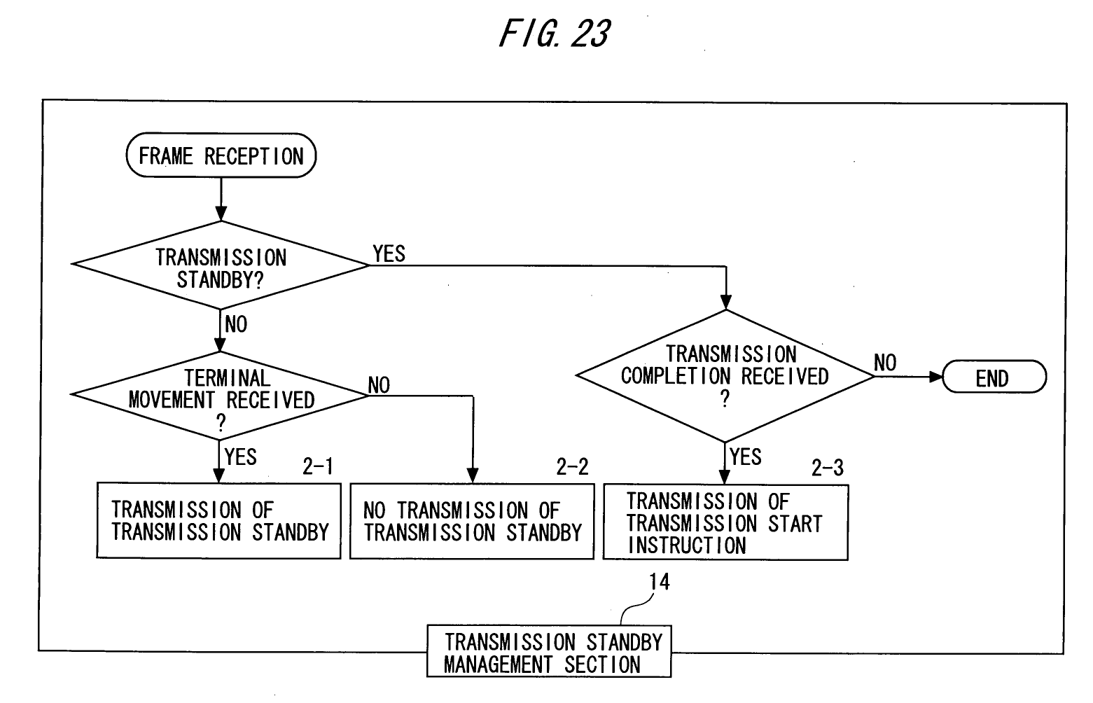

FIG. 23 is an explanatory view of the operation of the transmission standby management section 14 provided in the access point AP2 in the wireless LAN system shown in FIG. 22. When the received frame is a terminal movement notification frame from the wired NW, the transmission standby management section 14 generates a transmission standby instruction frame to transmit the transmission standby instruction frame to the terminal 2 under its control (procedures 2-1 and 2-2). When the transmission standby management section receives the notification of completion of the transmission from the terminal 1 currently transmitting data by priority, which is already in the transmission standby state, a transmission start instruction frame is generated to be transmitted to the terminal 2 in the transmission standby state (a procedure 2-3).

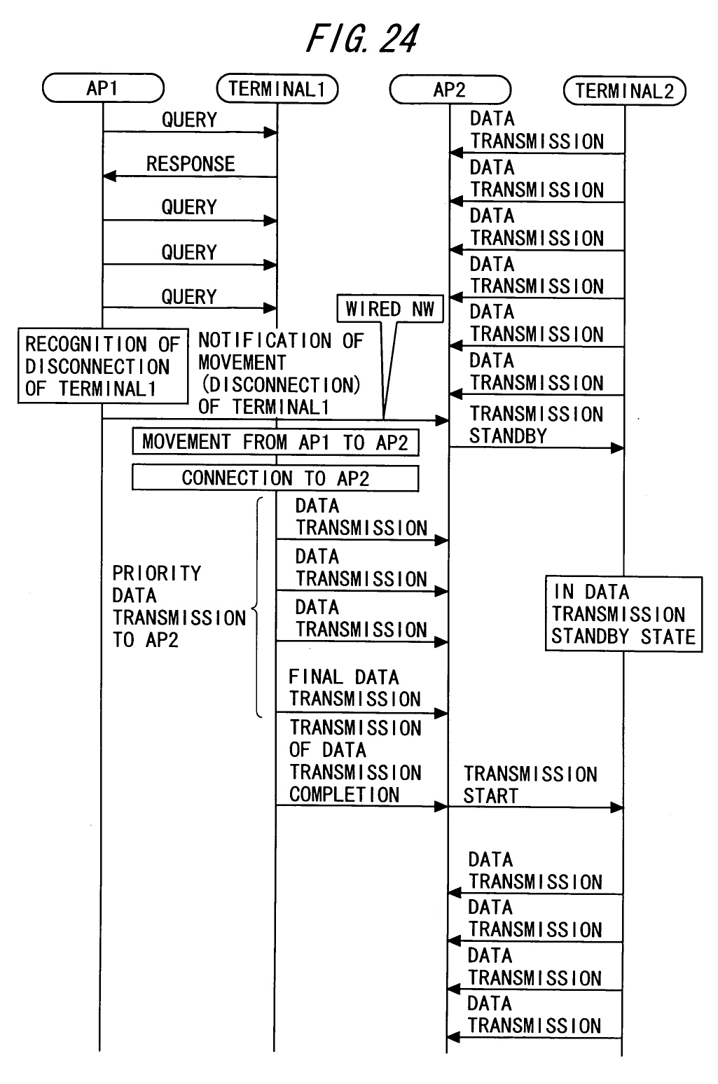

FIG. 24 is an operation sequence diagram in the wireless LAN system shown in FIG. 22. As shown in FIG. 24, when the terminal 1 connected to the access point AP1 moves to the access point AP2, the access point AP1 transmits a notification of movement (disconnection) of the terminal 1 to the access point AP2 through the wired NW. The access point AP2 transmits a transmission standby instruction to the terminal 2 under its control. The terminal 2 waits for data transmission until it receives the transmission start instruction. Meanwhile, the terminal 1 can transmit data by priority to the access point AP2. The terminal 1 that completes the data transmission notifies the access point AP2 of the completion of transmission. The access point AP2 receiving the completion of transmission transmits a transmission start instruction to the terminal 2 in the data transmission standby state under its control. In response to the transmission start instruction, the terminal 2 restarts the data transmission.

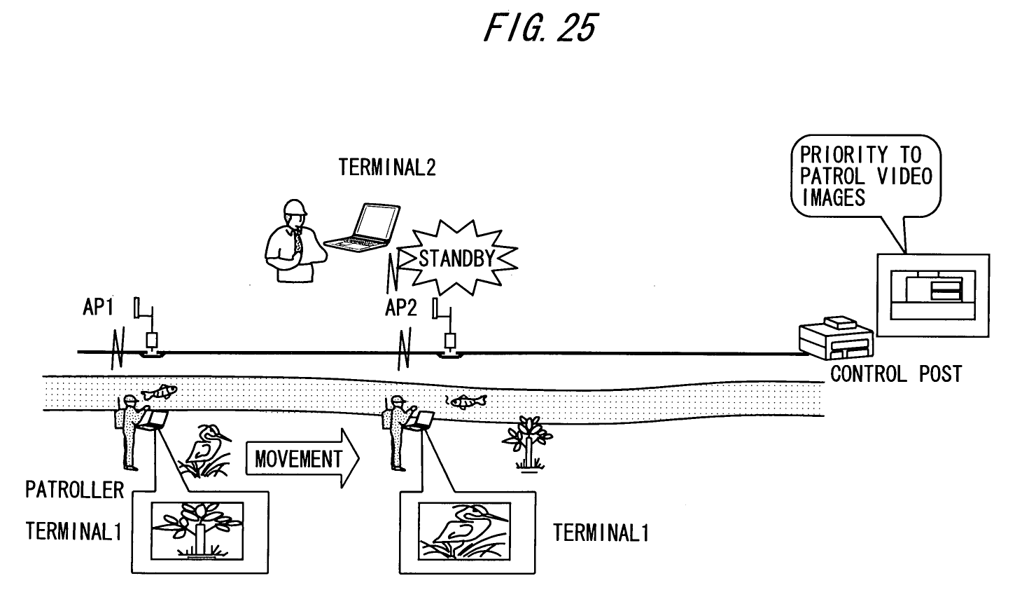

FIG. 25 is an example of application of the wireless LAN system shown in FIG. 22. As illustrated, in the example of application, a patroller using the terminal 1 transmits a video image at each monitor point to a control post (a monitor center) connected to the wired NW while moving in the wireless zones under the control of the access points AP1 and AP2. Since the control post performs centralized monitoring based on the video images (patrol video images) from the terminal 1 of the patroller, the patrol video images are desired to be received by priority when the patroller moves between the monitor points. Therefore, data from the other terminal 2 at the point to which the patroller moves is made to wait for transmission. According to the example of application, the control post on the wired NW can receive video images at a disaster site showing a state of a river or the like earlier than any other data in the event of a disaster.

### Second Operation Example

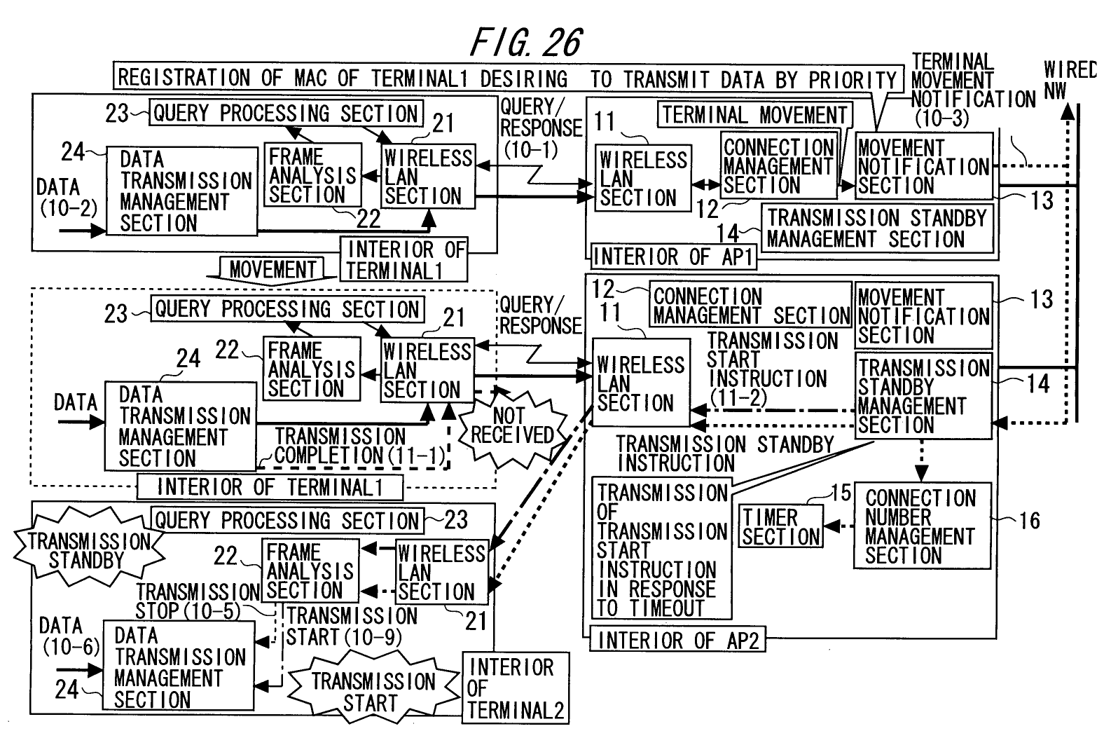

As shown in FIG. 26, the access point AP2 controlling the wireless zone RZ2 at the destination of the terminal 1 further includes a timer section 15 and a connection number management section 16.

The timer section 15 generates a timer value after the transmission of the transmission standby instruction from the transmission standby management section 14 in consideration of the case where the transmission completion (a procedure 11-1) from the terminal 1 that has completed the priority data transmission in the first operation example described above is not received by the access point AP2 due to an error in the wireless area. Even if the transmission standby management section 14 of the access point AP2 does not receive the transmission completion notification transmitted from the data transmission management section 24 of the terminal 1, the transmission start instruction (a procedure 11-2) is transmitted in response to timeout of the timer value to transit the terminal 2 from the data transmission standby state to the data transmission restart state.

Furthermore, the connection number management section 16 has a function of changing the timer value in accordance with the number of terminals connected to the access point AP2 to regulate a data transmission standby duration of the terminal 2.

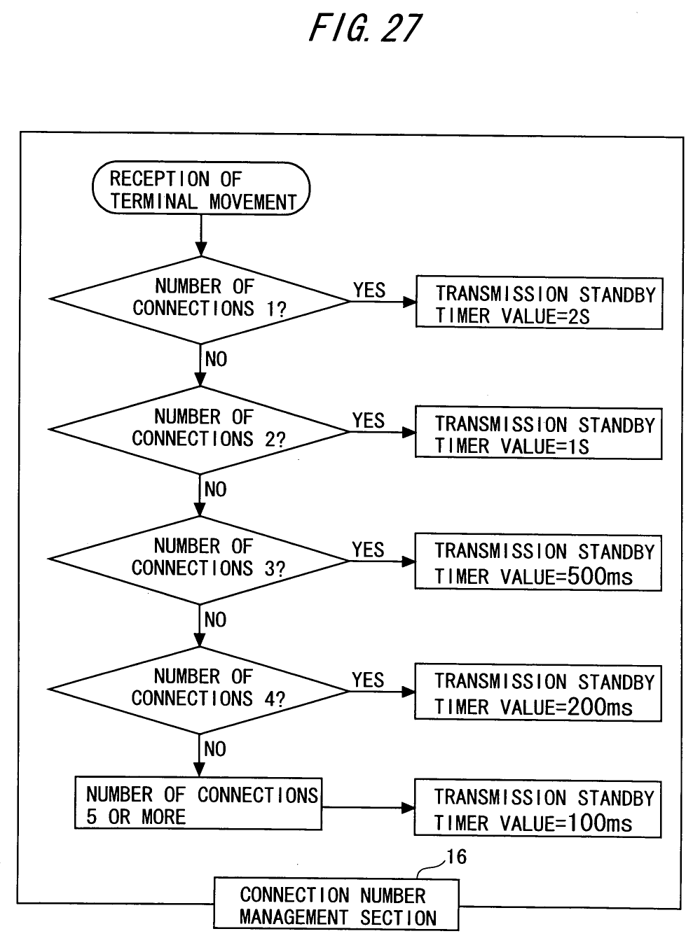

FIG. 27 is an explanatory view of an operation of the connection number management section 16 provided in the access point AP2 in the wireless LAN system shown in FIG. 26. When the connection number management section 16 is notified of the reception of the terminal movement notification from the access point AP1 through the wired NW, it determines a timer value in accordance with the number of currently connected terminals (the number of connections). The timer value determined in the connection number management section 16 is set to the timer section 15. In this example, when the number of connections is “1”, the transmission standby timer value is 2 sec. (seconds). When the number of connections is “5” or more, the transmission standby timer value is 100 msec. (milliseconds). In this manner, the transmission standby timer value is determined to decrease as the number of connections increases.

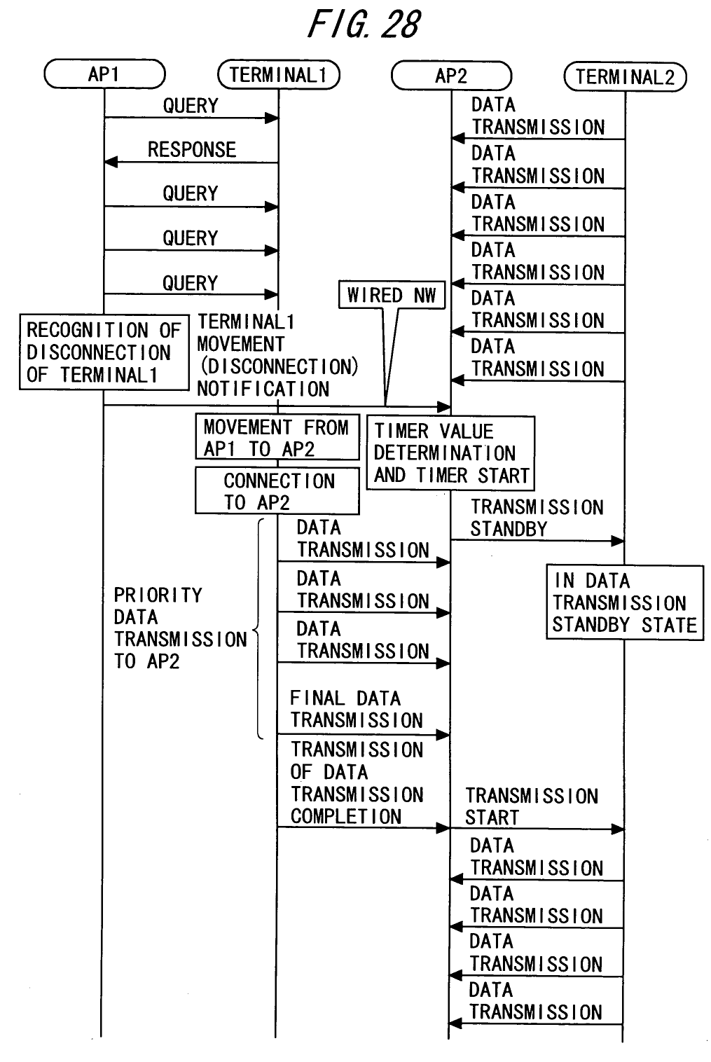

FIG. 28 is an operation sequence diagram in the wireless LAN system shown in FIG. 26. As shown in FIG. 28, at the access point AP2, after the timer value is determined in accordance with the number of connected terminals, the timer is started. As a result, even if the access point AP2 cannot receive the transmission completion notification from the terminal 1, it can allow the terminal 2 in the transmission standby state to restart the data transmission in response to the occurrence of timeout.

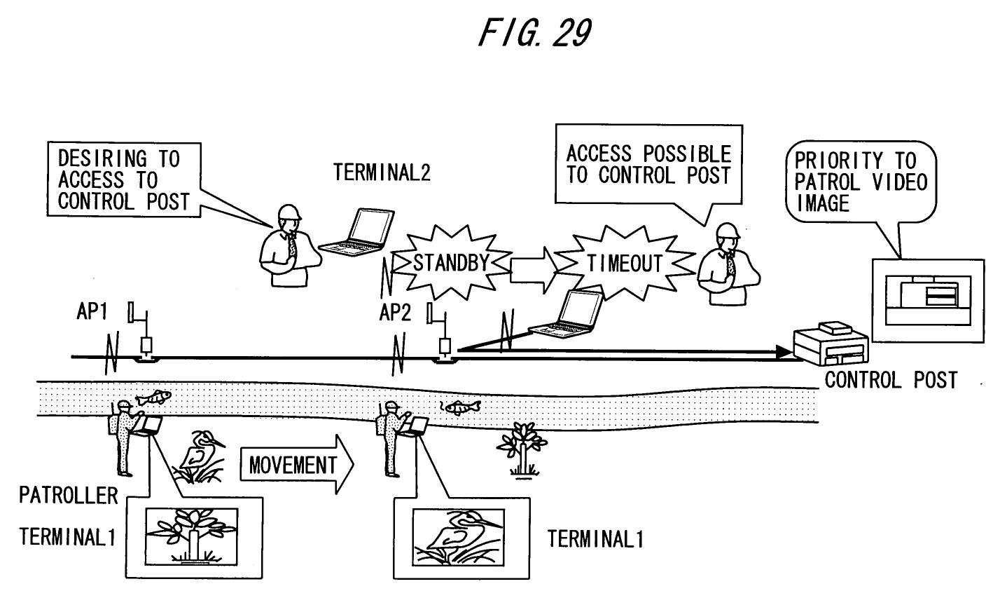

FIG. 29 shows an example of application of the wireless LAN system shown in FIG. 26. As illustrated, in the example of application, the patroller using the terminal 1 transmits video images at each monitor point to the control post connected to the wired NW while moving in the wireless zones under the access points AP1 and AP2. Since the control post performs centralized monitoring based on the video images (patrol video images) from the terminal 1 of the patroller, the patrol video images are desired to be received by priority when the patroller moves between the monitor points. Therefore, data from the other terminal 2 at the point to which the patroller moves is made to wait for transmission.

According to this, the transmission completion notification from the terminal 1 used by the patroller cannot be received at the access point AP2 in some cases because of the occurrence of an error in the wireless area. Even in such a case, the data transmission of the terminal 2 in the transmission standby state can be restarted in response to timeout of the timer (the timer section 15). Moreover, when a large number of terminals are connected under the control of the access point AP2, the frequency of data transmission is expected to be increased. Even in such a case, since the timer value can be decreased in accordance with the number of connected terminals, the data transmission standby period can be reduced.

### Third Operation Example

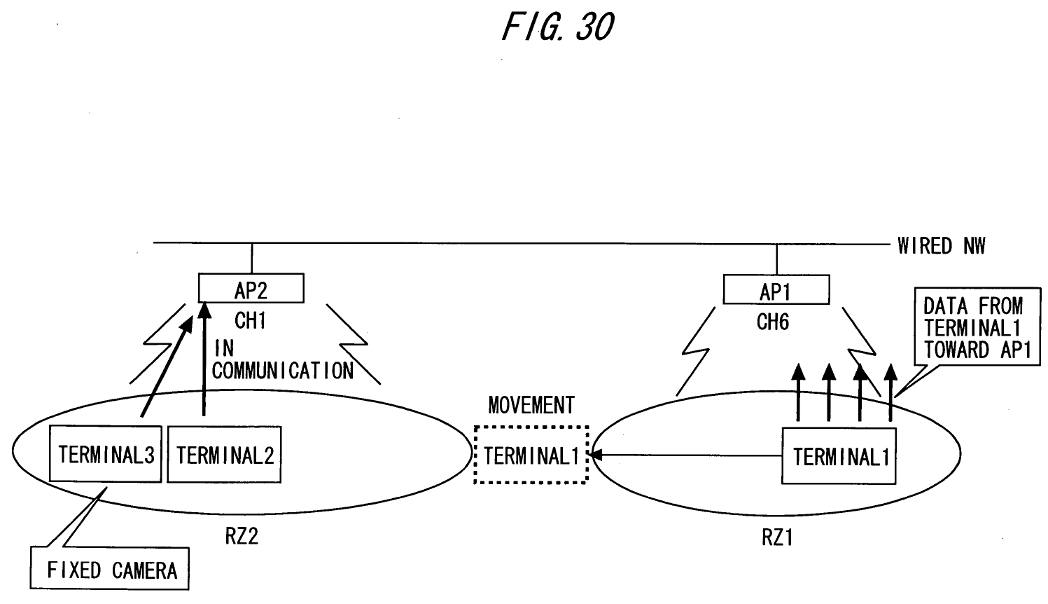

In an environment of the wireless LAN system having the priority data transmission function shown in FIG. 30, the terminals 2 and 3 are connected under the control of the access point AP2. Data transmitted from the terminal 3 is video data from a fixed camera installed at the monitor point. Therefore, since priority cannot be given only to the data transmission from the terminal 1 moving from the access point AP1, only the terminal 2 is made to wait for the data transmission.

At this time, the frame illustrated in FIG. 15 is used as a transmission standby designation frame transmitted from the access point AP2. At the access point AP2, a MAC address of the terminal 3 that does not wait for transmission is preset. On the other hand, the access point AP2 designates an MAC address of the terminal 2 waiting for transmission based on the preset MAC address to bring it into a transmission standby state. As a result, since it is possible to designate the terminal 2 that is desired to be made to wait for transmission, the order of priorities of data transmission in the wireless zone RZ2 can be determined.

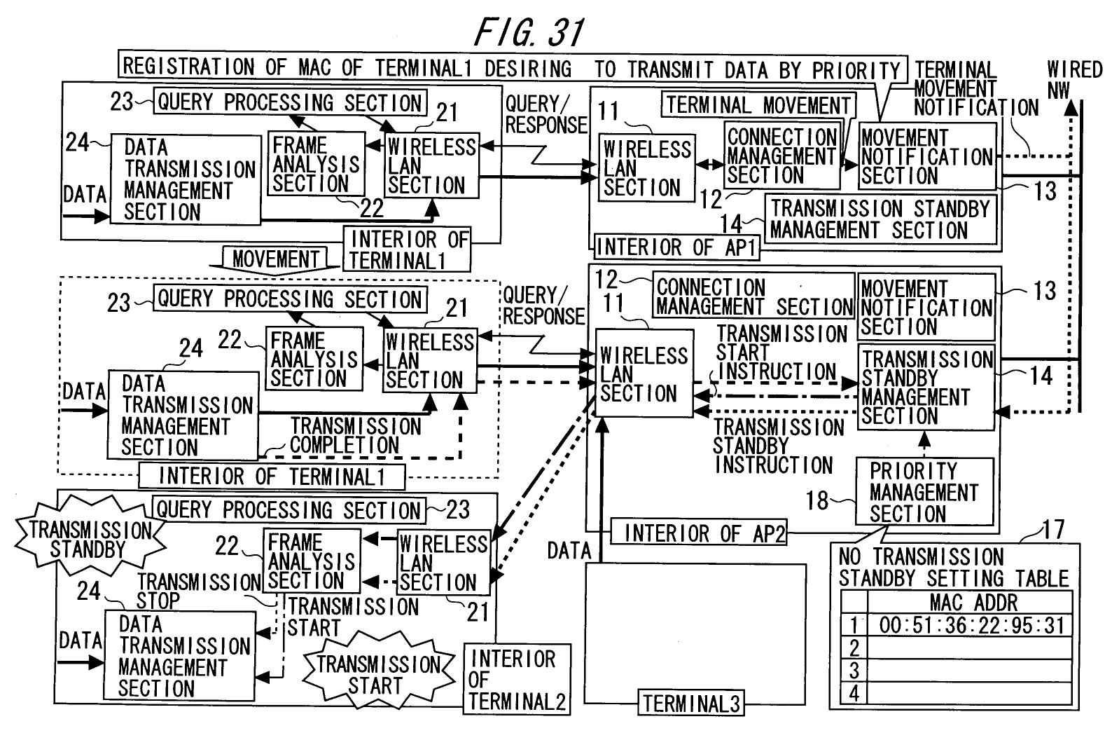

As shown in FIG. 31, the access point AP2 controlling the wireless zone RZ2 at the destination of the terminal 1 further includes a priority management section 18 having a no transmission standby setting table 17. In the table 17 of the priority management section 18, a MAC address of a terminal (the terminal 3) that does not wait for transmission is preregistered. The transmission standby management section 14 searches for a terminal that does not wait for transmission in the table 17 in the priority management section 18. Since the MAC address of the terminal 3, 00:51:36:22:96:31, is set as identification information in the setting table 17, the MAC address is removed from the list of terminals currently connected to the access point AP2. Then, the transmission standby designation frame is generated to be transmitted. As a result, the data transmission right is passed between the terminal 3 that does not wait for transmission and the terminal 1 that desires to transmit data by priority.

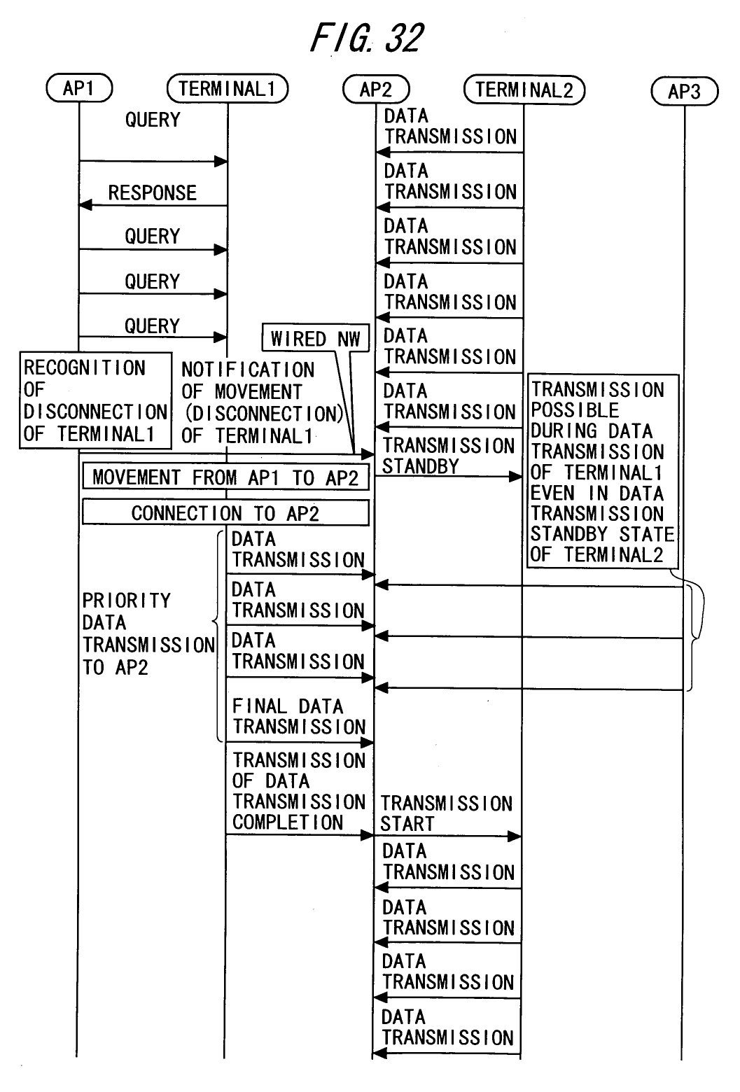

FIG. 32 is an operation sequence diagram in the wireless LAN system shown in FIGS. 30 and 31. As shown in FIG. 32, since the terminal 3 is not in the transmission standby state, interrupt data transmission is possible during the data transmission of the terminal 1. Since the terminal 1 does not have absolute priority, the data transmission efficiency is lowered as compared with the case where it has the absolute priority. However, the access point AP2 can receive the data from both the terminals 1 and 3.

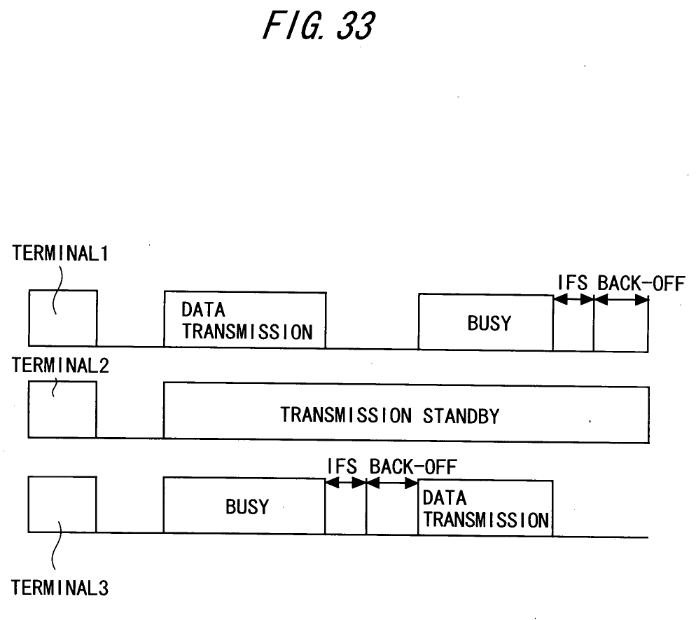

FIG. 33 shows an access procedure of the terminals 1, 2 and 3 in the wireless LAN system shown in FIGS. 30 and 31. As shown in FIG. 33, only the terminal 2 is brought into a transmission standby state in response to the transmission standby instruction from the access point AP2. The terminals 1 and 3 cannot transmit data during their data transmission because it is determined that the wireless area is busy. However, it is determined that the wireless area is free based on transmission intervals after the data transmission to enable the data transmission.

### Fourth Operation Example

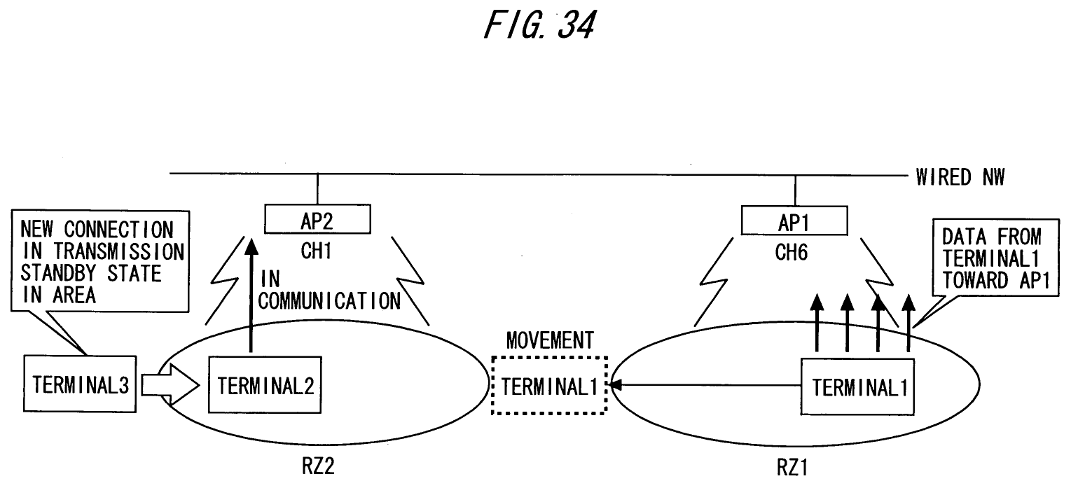

In an environment of the wireless LAN system having the priority data transmission function shown in FIG. 34, the terminal 2 present in the wireless zone RZ2 under the control of the access point AP2 is already in a transmission standby state. When the terminal 3 in the wireless zone RZ2 is newly connected to the access point AP2 in this state, the terminal 3 can transmit data because the transmission standby instruction is not issued to it. Even if the terminal 1 moves from the wireless zone RZ1 under the control of the access point AP1 to the wireless zone RZ2 under the control of the access point AP2, it cannot transmit data by priority.

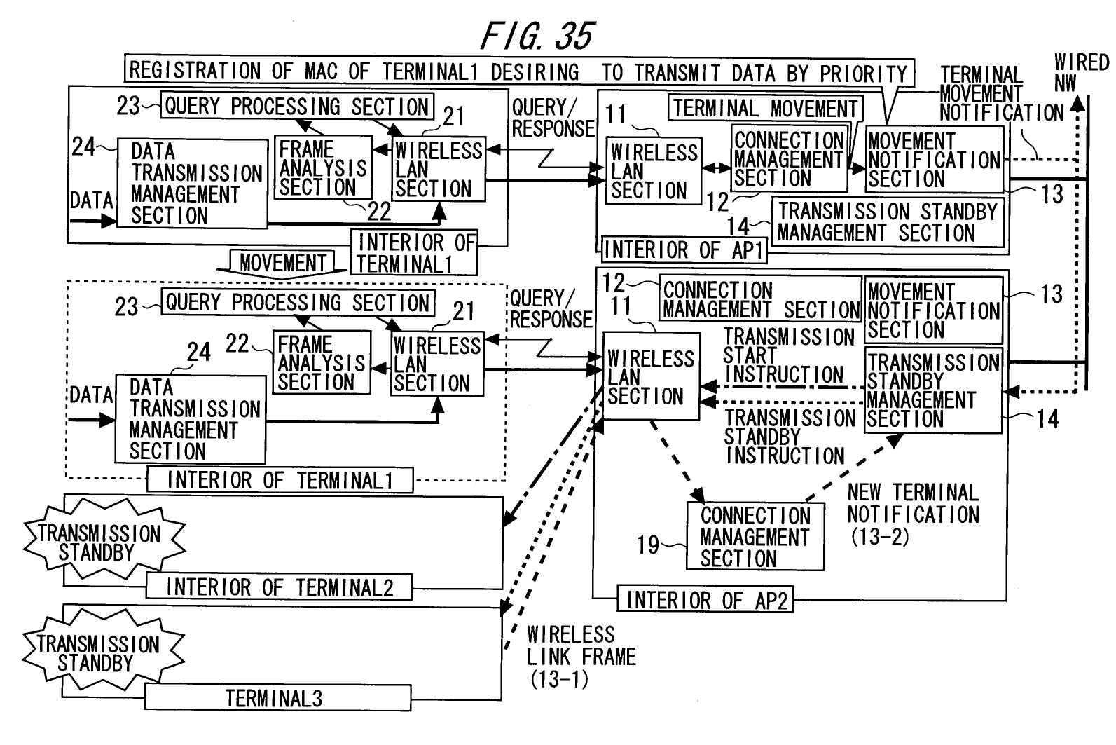

As shown in FIG. 35, the access point AP2 controlling the wireless zone RZ2 at the destination of the terminal 1 further includes a connection management section 19. At the access point AP2 receiving a wireless link frame of a wireless connection request (a procedure 13-1) from the new terminal 3, the connection management section 19 recognizes the connection of the new terminal 3 to notify the transmission standby management section 14 of the new terminal (a procedure 13-2). The transmission standby management section 14 receiving the notification transmits the transmission standby instruction to the terminal 3 (a procedure 13-3). As a result, even if the new terminal 3, which is already in the transmission standby state, is connected in the wireless zone RZ2, the data transfer efficiency of the terminal 1 that desires to transmit data by priority can be prevented from being degraded (obstructed) because the transmission standby instruction can be issued to the terminal 3.

### VARIATIONS

The processes in the embodiment described above are provided as a program executable on a computer, and can be provided through a recording medium such as a CD-ROM or a flexible disk or furthermore through a communication line.

A plurality of arbitrary ones of or all of the processes in the embodiment described above can be selected to be executed in combination.

1. A communication control device constituting an access point of a wireless LAN system, comprising:
a unit receiving a movement advance notification of a terminal into a wireless zone under control; and
a unit transmitting a transmission standby instruction so that a terminal transmitting data is brought into a wait state and a movement target terminal moving into the wireless zone under the control is allowed to transmit data by priority upon reception of the movement advance notification.

2. The communication control device according to claim 1, wherein the communication control device constitutes any one of a plurality of access points logically connected in cascade arrangement to a wired network having a monitor center of data with urgency.

3. The communication control device according to claim 1, further comprising:
a unit transmitting a transmission start instruction for allowing the terminal in the standby state to restart the data transmission upon reception of a data transmission completion notification from the movement target terminal.

4. The communication control device according to claim 1, further comprising:
a unit generating a timer value after transmission of the transmission standby instruction; and
a unit transmitting a transmission start instruction allowing the terminal in the standby state to restart the data transmission.

5. The communication control device according to claim 1, further comprising:
a unit transmitting a transmission start instruction for allowing the terminal in the standby state to restart the data transmission in response to timeout of a timer value after the transmission of the transmission standby instruction when a data transmission completion notification from the movement target terminal cannot be received.

6. The communication control device according to claim 4, further comprising:
a unit changing the timer value in accordance with the number of connected terminals.

7. The communication control device according to claim 1, further comprising:
a unit storing identification information of a terminal that is not brought into a complete standby state for data transmission; and
a unit allowing the terminal not being in the standby state to perform interrupt data transmission during data transmission of the movement target terminal based on a search of the identification information.

8. The communication control device according to claim 1, further comprising:
a unit receiving the movement advance notification to bring the terminal transmitting data into the standby state and for further transmitting a transmission standby instruction to a newly connected terminal in the wireless zone to allow the movement target terminal moving into the wireless zone under the control to transmit data by priority.

9. A communication control method in an access point of a wireless LAN system, comprising:
receiving a movement advance notification of a terminal into a wireless zone under control; and
transmitting a transmission standby instruction so that a terminal transmitting data is brought into a wait state and a movement target terminal moving into the wireless zone under the control is allowed to transmit data by priority upon reception of the movement advance notification.

10. The communication control method according to claim 9, wherein the method is executed in any one of a plurality of access points logically connected in cascade arrangement to a wired network having a monitor center of data with urgency.

11. The communication control method according to claim 9, further comprising:
transmitting a transmission start instruction for allowing the terminal in the standby state to restart the data transmission upon reception of a data transmission completion notification from the movement target terminal.

12. The communication control method according to claim 9, further comprising:
generating a timer value after transmission of the transmission standby instruction; and
transmitting a transmission start instruction allowing the terminal in the standby state to restart the data transmission.

13. The communication control method according to claim 9, further comprising:
transmitting a transmission start instruction for allowing the terminal in the standby state to restart the data transmission in response to timeout of a timer value after the transmission of the transmission standby instruction when a data transmission completion notification from the movement target terminal cannot be received.

14. The communication control method according to claim 12 A, further comprising:
changing the timer value in accordance with the number of connected terminals.

15. The communication control method according to claim 9, further comprising:
storing identification information of a terminal that is not brought into a complete standby state for data transmission; and
allowing the terminal not being in the standby state to perform interrupt data transmission during data transmission of the movement target terminal based on a search of the identification information.

16. The communication control method according to claim 9, further comprising:
receiving the movement advance notification to bring the terminal transmitting data into the standby state and of further transmitting a transmission standby instruction to a newly connected terminal in the wireless zone to allow the movement target terminal moving into the wireless zone under the control to transmit data by priority.
